(19) United States
(12) Patent Application Publication
(10) Pub. No.: US 2012/0327661 A1
(43) Pub. Date: Dec. 27, 2012

(54) ALIGNMENT STRUCTURE, LASER LIGHTING SOURCE MODULE AND OPTICAL ALIGNMENT METHOD

(75) Inventors: Chung-I CHIANG, Taoyuan (TW); Min-Ching LIN, Taoyuan (TW)

(73) Assignee: WALSIN LIHWA CORPORATION, Taoyuan (TW)

(21) Appl. No.: 13/239,423

(22) Filed: Sep. 22, 2011

(30) Foreign Application Priority Data
Jun. 21, 2011 (TW) 100121708

(51) Int. Cl. G02B 27/20; B23P 11/00

(52) U.S. Cl. 362/259; 29/464

(57) ABSTRACT

An alignment structure, a laser lighting source module and an optical alignment method are provided. The laser lighting source module includes a substrate and a laser carrier. The substrate includes a first body and a first surface structure. The first surface structure is disposed on a surface of the first body. The laser carrier is used for carrying a laser emitter which includes a second body and a second surface structure. The second surface structure is disposed on a surface of the second body. At least a portion of the second surface structure is correspondingly engaged with at least a portion of the first surface structure so that the laser carrier may be aligned on the substrate.

This application claims the benefit of Taiwan patent application No. 100121708, filed on Jun. 21, 2011, the disclosure of which is incorporated herein by reference.

### BACKGROUND OF THE INVENTION

1. Field of the Invention

The invention relates to a lighting source module and an alignment method, and more particularly, to a laser lighting source module and an optical alignment method.

2. Description of the Related Art

With the development of technology, various optical modules become miniaturized. As the optical modules are getting smaller and smaller, the precision in the manufacturing of optical modules must be further increased.

The researchers found that the factors affecting the precision of optical modules at least include the alignment inaccuracies of the element fabricating and the variation in the manufacturing process.

The assembly equipments used for fabricating elements usually cannot achieve high level of precision condition. The researchers found that although the precision of the fabricating equipments has been calibrated to achieve the best condition, it is still hard to meet the precision requirement in the alignment of optical modules.

Taking full color (RGB) laser lighting source module as an example, the conventional module structure includes three (i.e., red, green, and blue) transistor outline-can (TO-can) elements and several optical filters. The optical axes of the three laser lighting sources must be located at the same position for mixing the light of full color lighting sources. Due to the size limit of the TO-Can elements, the volume of the lighting source module of the above-mentioned structure is about 5 to 7 cm³ and this cannot be further reduced. Furthermore, since the optical axes of the lighting source modules must be located at the same position, the fabricating precision requirements of the lighting source modules thus will be very high. Particularly, since the light coupling alignment needs to be applied to the red, blue, and green lighting sources, respectively, the fabricating process becomes more difficult and time-consuming, and a solution must be provided thereby.

Besides, the element fabricating includes several processes such as reflowing process, packaging process, and cleaning process. The researchers found that these processes will also severely affect the alignment precision of optical modules.

These factors severely affect the alignment precision of optical modules, and become a giant bottleneck to the miniaturization technology. Therefore, the researchers are dedicated to conducting relevant research so as to further improve the miniaturization technology of optical modules.

### SUMMARY OF THE INVENTION

An object of the invention is to provide a laser lighting source module and an optical alignment method. The substrate is able to engage with the laser carrier through the design of their surface structure, so that the laser carrier can be easily aligned on the substrate. In addition, the alignment precision may be improved and the complicated alignment procedures between the elements may be simplified.

Another object of the present invention is to provide a laser lighting source module. The laser lighting source module includes a substrate and a laser carrier. The substrate includes a first body and a first surface structure. The first surface structure is disposed on a surface of the first body. The laser carrier is used for carrying a laser emitter which includes a second body and a second surface structure. The second surface structure is disposed on a surface of the second body. At least a portion of the second surface structure is correspondingly engaged with at least a portion of the first surface structure so that the laser carrier may be aligned on the substrate.

An alternative object of the present invention is to provide an optical alignment method. The optical alignment method includes the following steps. A first surface structure is formed on a surface of a substrate. A first portion and a second portion of the first surface structure are extended along a first direction and a second direction respectively. The first direction and the second direction are not parallel to each other. A second surface structure is formed on a surface of at least one optical element. At least a portion of the second surface structure is correspondingly engaged with at least a portion of the first surface structure. At least one optical element is located on the substrate so that the at least one optical element may be aligned on the substrate.

A further object of the present invention is to provide an alignment structure used in a laser lighting source module. The laser lighting source module includes a substrate and a laser carrier. The alignment structure includes a first surface structure and a second surface structure. The first surface structure is disposed on a surface of the substrate, and the second surface structure is disposed on a surface of the laser carrier. At least a portion of the second surface structure is correspondingly engaged with at least a portion of the first surface structure so that the laser carrier may be aligned on the substrate.

The detailed technology and the preferred embodiment(s) implemented for the present invention are described in the following paragraphs accompanying the drawings for people skilled in this field to well appreciate the features of the present invention.

### BRIEF DESCRIPTION OF THE DRAWINGS

FIG. 1 is a schematic diagram illustrating a laser lighting source module according to an embodiment of the invention;

FIG. 2 is a bottom view of a laser carrier according to the embodiment of the invention;

FIG. 3 is a top view of the laser carrier according to the embodiment of the invention;

FIG. 4 is a front view of the laser carrier according to the embodiment of the invention;

FIG. 5 is a right side view of the laser carrier according to the embodiment of the invention; and

FIG. 6 is a flowchart of an optical alignment method according to the embodiment of the invention.

### DETAILED DESCRIPTION OF THE INVENTION

A number of embodiments are disclosed below for detailed descriptions of the invention. The embodiments utilize the design of using the surface structures between specific optical elements as alignment structures so that the specific optical elements (e.g., the substrate and the laser carrier) may be engaged with each other. Therefore, the specific optical elements may be aligned precisely, and the alignment precision of the elements may be significantly improved by a simple way. However, the embodiments are used for exemplification purpose only, not for limiting the scope of the invention. In addition, in some embodiments, parts of the elements are omitted to highlight the technical features of the invention.

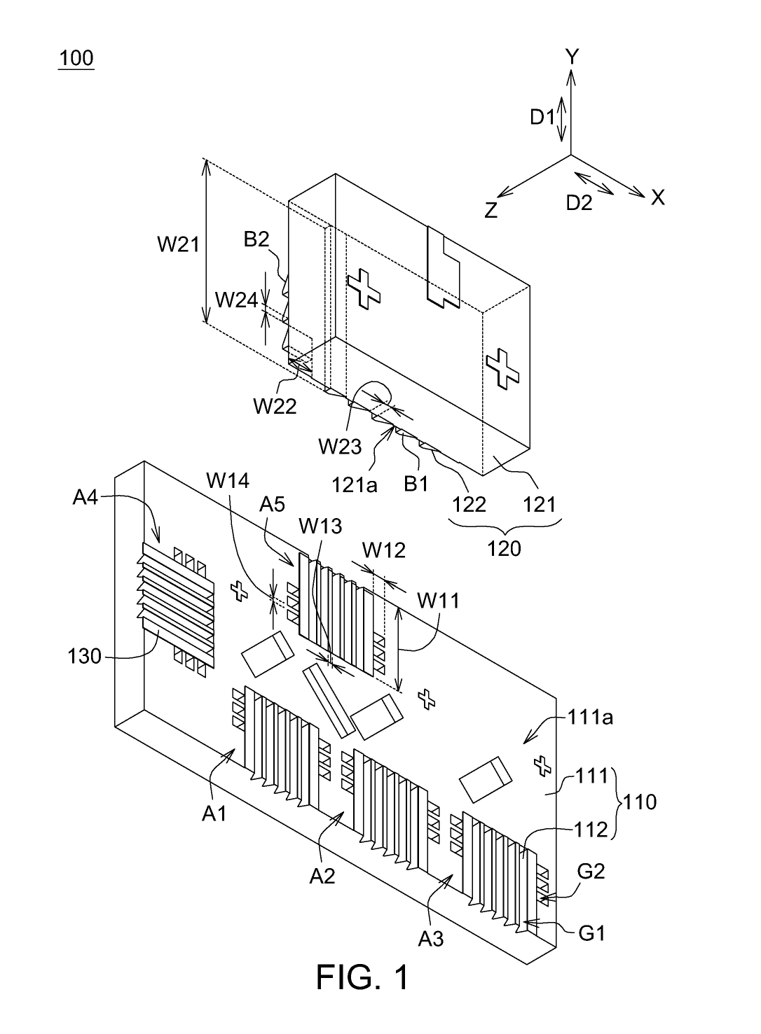

FIG. 1 is a schematic diagram of a laser lighting source module 100 according to an embodiment of the invention. The laser lighting source module 100 includes a substrate 110, at least one laser carrier 120 and an alignment structure. The substrate 110 may be, for example, a silicon optical bench, an aluminum nitride (AlN) substrate or an aluminum oxide substrate (Al₂O₃), but not limited thereto. The laser carrier 120 is used for carrying a laser emitter (not shown). The laser carrier 120 may be, for example, an aluminum nitride (AlN) substrate or an aluminum oxide (Al₂O₃) substrate, but not limited thereto. The number of laser emitters carried by the laser carrier 120 is not limited to one. In the embodiment, each laser carrier 120 carries only one laser emitter. The number of laser carriers 120 disposed on the substrate 110 is not limited to one. In the embodiment, the substrate 110 may have one to five laser carriers 120 disposed thereon, and the substrate 110 may also carry one or several optical lens assemblies (not shown) which operate in conjunction with the laser emitter(s) disposed on the laser carrier(s) 120. More specifically, the laser emitter carried by the laser carrier 120 can emit a laser light which may be radiated towards a predetermined direction via the optical lens assembly and a suitable optical path.

In the embodiment, the substrate 110 includes a first body 111 and a first surface structure 112. The first surface structure 112 may be, for example, a first concave-convex structure disposed on a surface 111a of the first body 111. On the other hand, the laser carrier 120 includes a second body 121 and a second surface structure 122. The second surface structure 122 may be, for example, a second concave-convex structure disposed on a surface 121a of the second body 121. Besides, the first body 111 and the second body 121 usually have a thickness of about 200 μm, but not limited thereto. Also, the alignment structure of the laser lighting source module 10 includes the first surface structure 112 and the second surface structure 122. It is noted that at least a portion of the second surface structure 122 is corresponding engaged with at least a portion of the first surface structure 112 so that the laser carrier 120 may be easily and precisely aligned on the substrate 110. In one embodiment, the second surface structure 122 may be substantially similar or identical to the first surface structure 112 in an opposite direction so that all or a portion of the second surface structure 122 may be engaged with all or a portion of the first surface structure 112.

As shown in FIG. 1, the first surface structure 112 of the substrate 110 has five similar areas A1, A2, A3, A4 and A5. The laser carrier 120 may be located on one of the five areas A1, A2, A3, A4 and A5 according to the actual arrangement of the element so as to correspondingly engage with the substrate 110.

As shown in FIG. 1, the first surface structure 112 (exemplified by the first concave-convex structure) includes at least one first groove G1 substantially extended along a first direction D1. The second surface structure 122 (exemplified by the second concave-convex structure) includes at least one first convex rib B1 substantially extended along the first direction D1. The cross section of the first groove G1 may be a trapezoid, and the cross section of the first convex rib B1 may also be a trapezoid. The cross section of the first groove G1 is substantially similar to the cross section of the first convex rib B1 but in an opposite direction. A length W11 of the first groove G1 is substantially not shorter than a length W21 of the first convex rib B1. Thus, the first groove G1 may be capable of containing the first convex rib B1 for enabling the laser carrier 120 to be easily and precisely aligned on the substrate 110. In one embodiment, the depth of the first groove G1 and that of the first convex rib B1 may be, for example, about 25 to 75 μm, but not limited thereto.

More specifically, in the embodiment, a plurality of first grooves G1 are interspaced by identical intervals W13, and a plurality of first convex ribs B1 are also interspaced by identical intervals W23. The intervals W13 between the first grooves G1 are substantially identical to the intervals W23 between the first convex ribs B1 so that each first convex rib B1 may be capable of engaging with the first groove G1.

Besides, the first groove G1 and the first convex rib B1 are extended along the first direction D1, so that the laser carrier 120 is limited by the first groove G1 and the first convex rib B1 and is only able to move along the first direction D1.

Furthermore, in the embodiment, the first surface structure 112 (exemplified by the first concave-convex structure) further includes at least one second groove G2 substantially extended along a second direction D2. The second surface structure 122 (exemplified by the second concave-convex structure) further includes at least one second convex rib B2 substantially extended along the second direction D2. The cross section of the second groove G2 may be a trapezoid, and the cross section of the second convex rib B2 may also be a trapezoid. The cross section of the second groove G2 is substantially similar to the cross section of the second convex rib B2 but in an opposite direction. A length W12 of the second groove G2 is substantially not shorter than a length W22 of the second convex rib B2. Thus, the second groove G2 may be capable of containing the second convex rib B2 for enabling the laser carrier 120 to be easily and precisely aligned on the substrate 110. In one embodiment, the depth of the second groove G2 and that of the second convex rib B2 may be, for example, about 25 to 75 μm, but not limited thereto.

In the embodiment, a plurality of second groove G2 are interspaced by identical intervals W14, and a plurality of second convex ribs B2 are also interspaced by identical intervals W24. The intervals W14 between the second grooves G2 are substantially identical to the intervals W24 between the second convex ribs B2 so that each second convex rib B2 may be capable of engaging with the second groove G2.

In addition, the second groove G2 and the second convex rib B2 are extended along the second direction D2, so that the laser carrier 120 is limited by the second groove G2 and the second convex rib B2 and is only able to move along the second direction D2.

To achieve the goal of precise alignment, the first direction D1 and the second direction D2 are not parallel to each other and must have an angle more than 0° therebetween. For example, the angle between the first direction D1 and the second direction D2 may be more than 45° or substantially equal to 90°. Therefore, a two dimensional limiting effect between the first surface structure 112 and the second surface structure 122 may be obtained, and the laser carrier 120 may be easily and precisely aligned on the substrate 110.

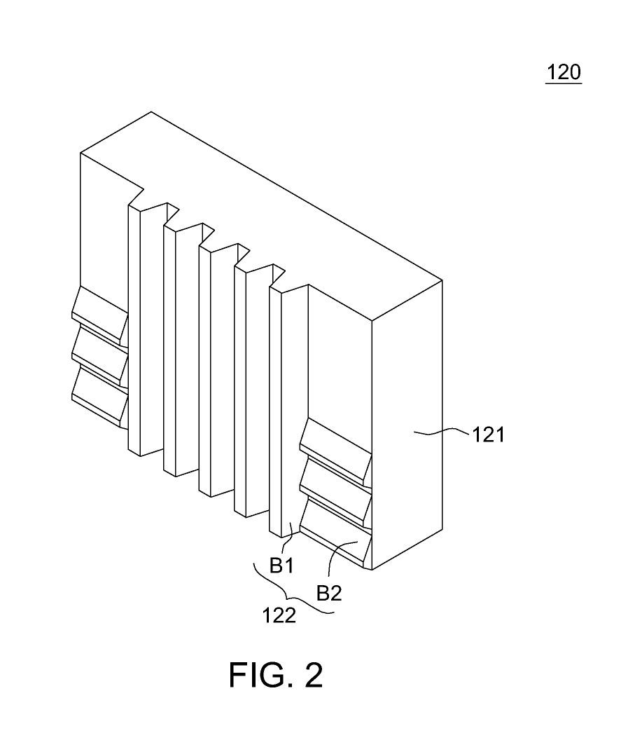

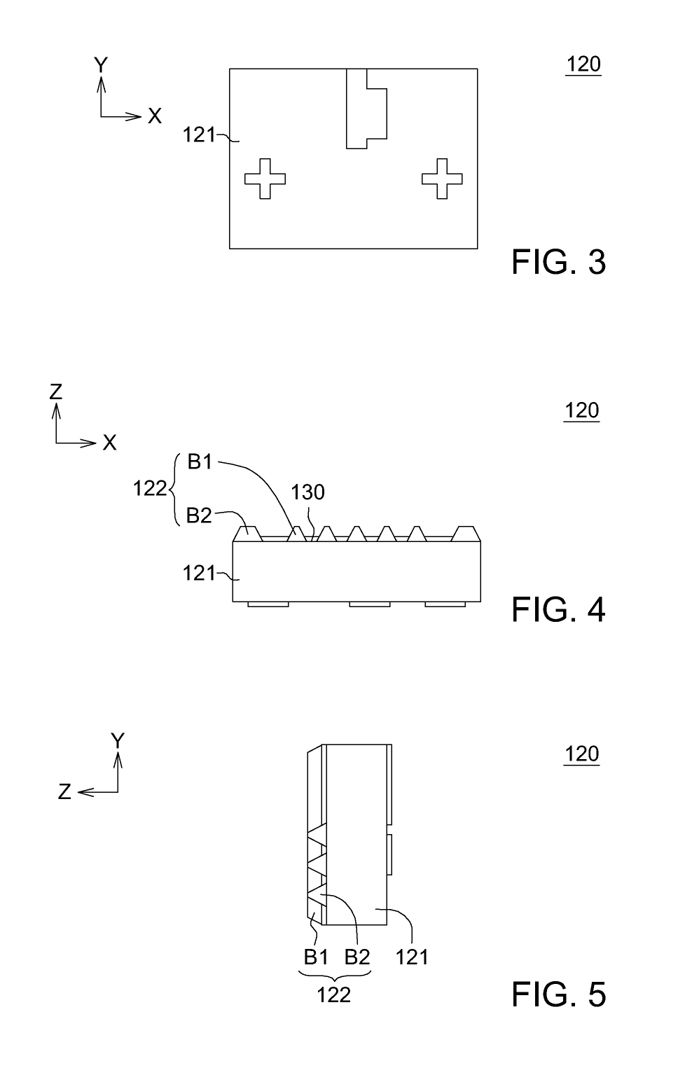

Please refer to FIGS. 2 to 5, FIG. 2 is a bottom view of a laser carrier 120; FIG. 3 is a top view of the laser carrier 120; FIG. 4 is a front view of the laser carrier 120; and FIG. 5 is a right side view of the laser carrier 120. The laser lighting source module 100 according to the embodiment of the invention further includes a solder metal layer 130 disposed on the surface of the first surface structure 112 or the surface of the second surface structure 122. In a preferred embodiment, as shown in FIGS. 1 to 5, the solder metal layer 130 is only disposed on the surfaces of the first body 111 and the second body 121 without covering the first surface structure 112 and the second surface structure 122 (i.e., the first groove G1, the second groove G2, the first convex rib B1 or the second convex rib B2). This may prevent the possible alignment error occurring at the bevel of the first groove G1, the second groove G2, the first convex rib B1 or the second convex rib B2 after the solder metal layer 130 being soldered.

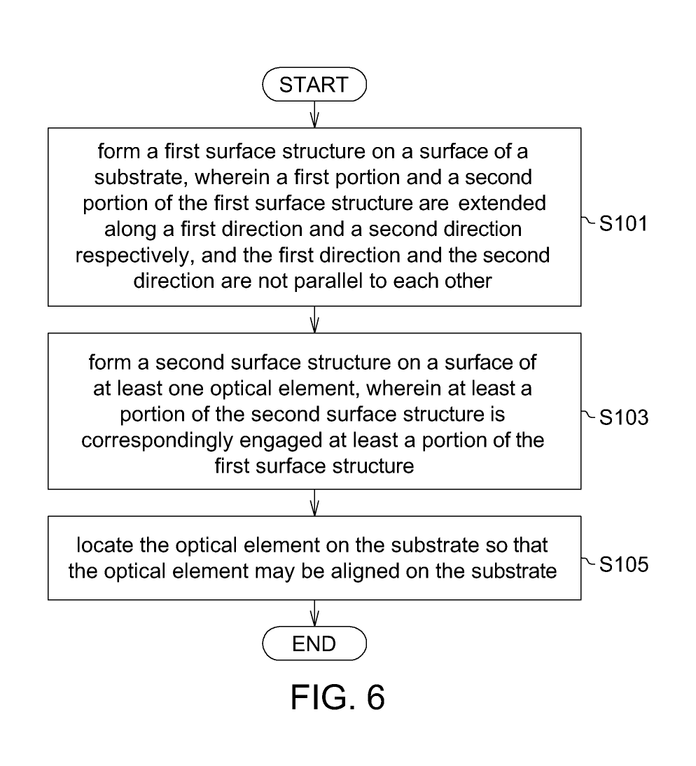

FIG. 6 is a flowchart of an optical alignment method according to the embodiment of the invention. The optical alignment method in this embodiment is exemplified by the laser lighting source module 100 of FIG. 1. However, people skilled in this field should understand that the optical alignment method of this embodiment is not limited to the laser lighting source module 100 of FIG. 1, and the laser lighting source module 100 of this embodiment is not limited to the optical alignment method of FIG. 6 either.

In step S101, a first surface structure 111 is formed on the surface 111a of the substrate 110. A first portion (exemplified by the first groove G1 of the first concave-convex structure) of the first surface structure 111 and a second portion (exemplified by the second groove G2 of the second concave-convex structure) of the first surface structure 111 are extended along the first direction D1 and the second direction D2 respectively. The first direction D1 and the second direction D2 are not parallel to each other and have an angle more than 0° therebetween.

In step S103, a second surface structure 122 is formed on a surface 121a of at least one optical element (exemplified by the laser carrier 120). At least a portion of the second surface structure 122 is correspondingly engaged with at least a portion of the first surface structure 112.

In step S105, the optical element (exemplified by the laser carrier 120) is located on the substrate 110 so that the optical element may be aligned on the substrate 110.

Prior to step S105, the solder metal layer 130 may be disposed on the first surface structure 112 and/or the second surface structure 122 so that the optical element (exemplified by the laser carrier 120) may be soldered and permanently fixed on the substrate 110.

The laser lighting source module and the optical alignment method disclosed in the above embodiments utilize the surface alignment technology of the silicon optical bench (SiOB) and the passive alignment so that the optical element (exemplified by the laser carrier) and the substrate may be easily engaged with each other. Therefore, the alignment precision may be improved and the complicated alignment procedures between the elements may be simplified.

While the invention has been described by way of example and in terms of the preferred embodiment(s), it should be understood that the invention is not limited thereto. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A laser lighting source module, comprising:
a substrate including a first body and a first surface structure, wherein the first surface structure is disposed on a surface of the first body; and
a laser carrier used for carrying a laser emitter, wherein the laser carrier includes a second body and a second surface structure, the second surface structure is disposed on a surface of the second body, and at least a portion of the second surface structure is correspondingly engaged with at least a portion of the first surface structure so that the laser carrier is aligned on the substrate.

2. The laser lighting source module according to claim 1, wherein the first surface structure is a first concave-convex structure, the second surface structure is a second concave-convex structure, and the first concave-convex structure is correspondingly engaged with the second concave-convex structure.

3. The laser lighting source module according to claim 2, wherein the first concave-convex structure comprises at least one first groove substantially extended along a first direction, and the second concave-convex structure comprises at least one first convex rib substantially extended along the first direction.

4. The laser lighting source module according to claim 3, wherein the first concave-convex structure comprises at least one second groove substantially extended along a second direction, the second concave-convex structure comprises at least one second convex rib substantially extended along the second direction, and an angle between the first direction and the second direction is more than 45°.

5. The laser lighting source module according to claim 4, wherein the angle between the first direction and the second direction is substantially 90°.

6. The laser lighting source module according to claim 3, wherein a length of the at least one first groove is substantially not shorter than a length of the at least one first convex rib, and a length of the at least one second groove is substantially not shorter than a length of the at least one second convex rib.

7. The laser lighting source module according to claim 1, wherein the first body is further used for carrying an optical lens assembly, and the laser emitter emits a laser light radiated outwards via the optical lens assembly.

8. The laser lighting source module according to claim 1, further comprising:
a solder metal layer disposed on a surface of the first surface structure.

9. The laser lighting source module according to claim 1, wherein the substrate is a silicon optical bench, an aluminum nitride (AlN) substrate or an aluminum oxide (Al₂O₃) substrate.

10. An optical alignment method, comprising:
forming a first surface structure on a surface of a substrate, wherein a first portion and a second portion of the first surface structure are extended along a first direction and a second direction respectively, and the first direction and the second direction are not parallel to each other;
forming a second surface structure on a surface of at least one optical element, wherein at least a portion of the second surface structure is correspondingly engaged with at least a portion of the first surface structure; and
locating the at least one optical element on the substrate so that the at least one optical element is aligned on the substrate.

11. The optical alignment method according to claim 10, wherein the step of locating the at least one optical element on the substrate further comprises:
disposing a solder metal layer on at least one of the first surface structure and the second surface structure.

12. An alignment structure, used in a laser lighting source module including a substrate and a laser carrier, comprising:
a first surface structure disposed on a surface of the substrate; and
a second surface structure disposed on a surface of the laser carrier, wherein at least a portion of the second surface structure is correspondingly engaged with at least a portion of the first surface structure so that the laser carrier is aligned on the substrate.
